(19) United States
(12) Patent Application Publication
(10) Pub. No.: US 2008/0186132 A1
(43) Pub. Date: Aug. 7, 2008

(54) ELECTRONIC KEY SYSTEM AND COMPONENT UNITS THEREFOR

(75) Inventor: Haruyuki IKEO, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/969,078

(22) Filed: Jan. 3, 2008

(30) Foreign Application Priority Data
Feb. 6, 2007 (JP) 2007-26909

(51) Int. Cl. B60R 25/00

(52) U.S. Cl. 340/5.7

(57) ABSTRACT

In an electronic key system for a vehicle, an in-vehicle unit transmits a request of response to a mobile unit together with information of a priority channel, and receives a response from the mobile unit by using the priority channel. If the response is not received successfully, the in-vehicle unit automatically changes and tries the transmission and reception again. If the response from the mobile unit is successfully received by using the changed channel, this channel is stored in a memory to be used as the priority channel in subsequent communications with the mobile unit.

### CROSS REFERENCE TO RELATED APPLICATION

This application is based on and incorporates herein by reference Japanese Patent Application No. 2007-26909 filed on Feb. 6, 2007.

### FIELD OF THE INVENTION

The present invention relates to an electronic key system and component units therefor.

### BACKGROUND OF THE INVENTION

An electronic key system is equipped in various control objects, such as a vehicle, an office building, a private house. In the case of the vehicle, the electronic key system includes an in-vehicle device mounted in the vehicle and a mobile unit carried by a vehicle user

In this electronic key system, the in-vehicle unit is allowed to lock or unlock vehicle doors and control starting of an engine without manual operation by a mechanical key, if it successfully communicates with the mobile unit by radio signals and confirms that the mobile unit is an authorized one. If the in-vehicle unit and the mobile unit use only one fixed frequency as a communication channel in communicating with each other, normal communication will be impeded by jamming because of an interfering wave appearing in the same frequency as the fixed communication channel.

JP 4-315681A proposes to counter this problem by switching over the communication channel to any one of a plurality of other channels of different frequencies. The communication channel is switched over by a user by manually selecting one of the channels. However, the channels will not be switched over by a switching operation, unless the user notices a communication failure arising from the jamming. Once the communication is performed successfully even under a condition in which unsuccessful communications will arise frequently, it is very likely that the user will not notice the unsuccessful communication and take any action to switch the channel. It is also likely that the user will switch over to a channel again which is also influenced by the jamming, if the switching operation is at the user's discretion.

It will be possible, in place of the manual switching operation, to switch over the channel to another one automatically by detecting an occurrence of unsuccessful communication arising from jamming. If the automatic switching is performed only in the predetermined order of sequence of channel arrangement, e.g., in the order of magnitude of frequencies, the successively arranged channels selected in sequence may be influenced by jamming because of similarity in frequencies. Therefore, the automatic switching will need a certain time to complete switching over to a channel, which is free from jamming. As a result, the in-vehicle unit will need comparatively long time to authenticate the mobile unit based on a radio signal transmitted from the mobile unit.

### SUMMARY OF THE INVENTION

It is therefore an object of the present invention to provide an electronic key system and component units therefor, which is capable of performing automatic channel switching in a short time.

In an electronic key system for a control object, an in-object unit and a mobile unit are provided. The in-object unit is provided in the control object such as a vehicle. The mobile unit communicates with the in-object unit by radio signals and causes the in-object unit to perform predetermined control in the control object. The mobile unit transmits a response to the in-object unit when receiving a request of response from the in-vehicle unit. The in-object unit selects one channel from a plurality of predetermined channels of communication for receiving the response from the mobile unit, and transmits information of the selected channel when transmitting the request of response to the mobile unit so that the mobile unit transmits the response by way of the selected channel. The in-object unit further selects another channel from the plurality of predetermined channels automatically when failing to receive the response transmitted from the mobile unit in response to the request of response, and transmits another request of response and information of the selected another channel so that the mobile unit transmits another response by using the selected another channel. Still further, the in-object unit selects the another channel for next radio communications with the mobile unit automatically after receiving the another response from the mobile unit successfully by using the selected another channel.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electronic key system according to an embodiment of the present invention;

FIG. 2 is a flow diagram showing smart entry function processing executed by an in-vehicle unit in the embodiment;

FIG. 3 is a table showing radio frequency channels used for communications in the embodiment;

FIG. 4 is a flow diagram showing smart entry function processing executed by a portable unit in the embodiment; and

FIG, 5 is a flow diagram showing remote keyless entry function processing executed in the embodiment.

### DETAILED DESCRIPTION OF THE EMBODIMENT

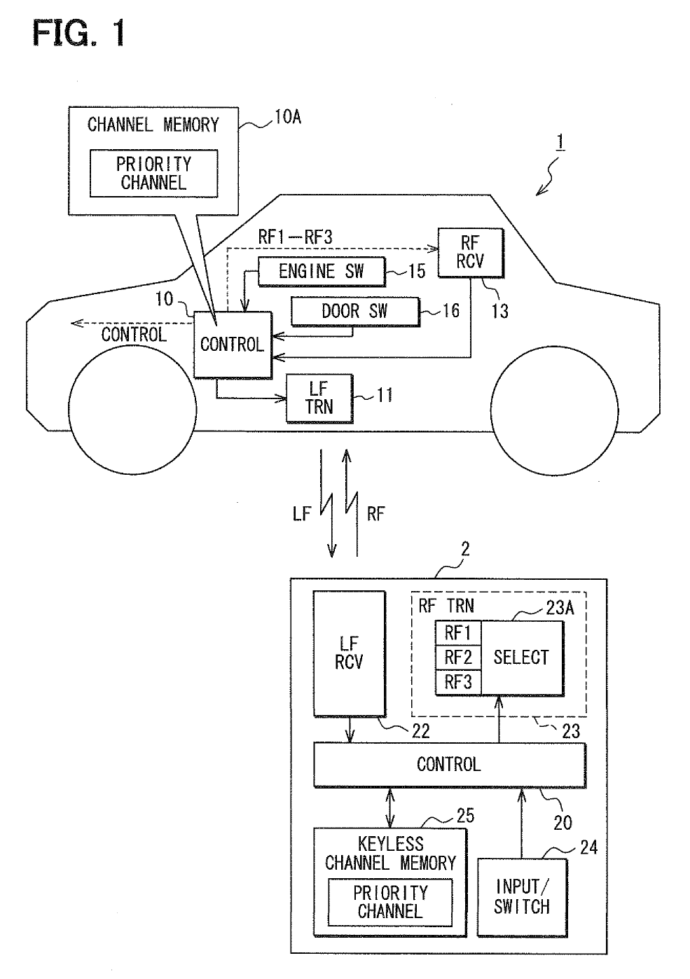

Referring first to FIG. 1, an electronic key system is provided for a vehicle as a control object. This system is configured by an in-vehicle unit 1 provided in a vehicle and a mobile unit 2 carried by a vehicle user This system has a smart entry function and a remote keyless entry function.

In the smart entry function, the in-vehicle unit 1 performs automatic door unlocking and the like when the user carrying the mobile unit 2 enters predetermined communication areas around the vehicle. In the remote keyless function, the in-vehicle unit performs automatic door locking/unlocking in response to the user's manual operation of the mobile unit 2 at a remote position.

The in-vehicle unit 1 includes an electronic controller 10, a low frequency (LF) transmitter 11, a radio frequency (RF) receiver 13, an engine switch 15, door switches 16, and the like.

The controller 10 is a microcomputer, which controls various devices in the vehicle, and has a non-volatile memory, In this non-volatile memory, a priority channel section 10A is provided to store priority channel information P, which is used in receiving radio signals from the mobile unit 2.

The LF transmitter 11 is for transmitting a radio signal of low frequency (LF) from the vehicle. This radio signal has a carrier wave in a LF frequency band of 100k-200k Hz, and hence is less influenced by interfering noises generated by communication cables, large display devices and the like. The radio signal transmitted from the LF transmitter 11 is limited to travel only a certain areas such as outside vehicle doors, inside a passenger compartment, inside a luggage compartment, outside a luggage compartment.

The RF receiver 13 is for receiving a radio signal of radio frequency transmitted from the mobile unit 2. This radio signal has a carrier wave in a UHF frequency band of 300M-400M Hz or 800M Hz, and hence is more influenced by the interfering noise than the LF frequency band. The RF receiver 13 is configured to be capable of communications with the in-vehicle unit 1 by selecting or switching over from one to another among three communication channels RF1, RF2, RF3 of different frequencies. The channel switching is automatically controlled by the controller 10.

The engine switch 15 is operable by a user when starting an engine. The controller 10 is configured to check whether the engine starting is to be allowed, when the engine switch 15 produces a detection signal indicative of the user's manual operation on the engine switch 15. The controller 10 is further configured to produce an engine start signal to an engine control system (not shown), if the engine starting is allowable.

Each door switch 16 is provided at a door handle, which the user operates to open the door. The controller 10 is configured to check whether the door opening is to be allowed, when the door switch 16 produces a detection signal indicative of the user's manual operation on the door handle. The controller 10 is configured to produce a door unlocking signal to a door locking/unlocking control system (not shown), if the door opening is allowable.

The mobile unit 2 includes a controller 20, a LF receiver 22, a RF transmitter 23, a switch section 24, a keyless communication channel memory 25, and the like.

The controller 20 is a microcomputer, which controls various operations in the mobile unit 2. The LF receiver 22 is for receiving the radio signal of low frequency transmitted from the in-vehicle unit 1. The RF transmitter 23 is for transmitting the radio signal of radio frequency, The RF transmitter 23 is configured to be capable of switching the channel over to one of three channels RF1, RF2, RF3 in response to an instruction signal from the controller 20, so that the selected channel to be used in signal transmission may match the selected channel of the RF receiver 13 in the in-vehicle unit 13.

The switch section 24 has a switch that is operated by the user to trigger a remote keyless entry function. When the switch section 24 is manually operated in a predetermined manner, the in-vehicle unit I performs door locking/unlocking control in the vehicle.

The channel memory 25 is a part of section of a non-volatile memory (not shown) built in the mobile unit 2, and stores channels to be used in transmitting an instruction signal to the in-vehicle unit 1 when performing the remote keyless entry function.

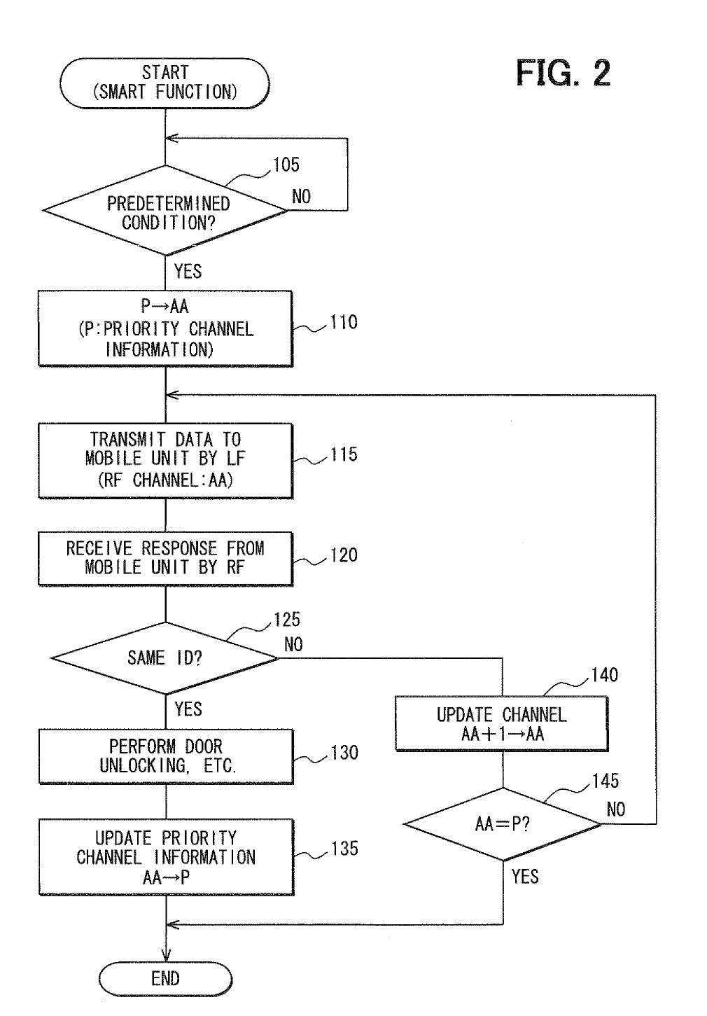

In operation, as shown in FIG. 2, the controller 10 in the in-vehicle unit 1 checks whether a predetermined communication condition is satisfied (step (S) 105). If the predetermined condition is not satisfied (NO), S105 is repeated. If the predetermined condition is satisfied (YES), the controller 10 executes the next S110. In S105, the predetermined communication may be set to include that the door switch is manually operated, the engine switch is manually operated and the like. It is possible to determine that the predetermined communication is satisfied every time a predetermined time elapses, in place of manual operation of the user.

The controller 10 registers at S110 priority channel information P in a variable AA of a temporary memory, e.g., register. The priority channel information P indicates a channel of frequency, which was successfully used to receive the radio signal from the mobile unit 2 in the latest communication. Therefore this channel should be used with highest priority

The controller 10 drives at S115 the LF transmitter 11 to transmit the radio signal to be received by the mobile unit 2. This radio signal includes data from the in-vehicle unit it This radio signal is transmitted by using the LF band so that the area for detecting the mobile unit 2 may be limited to only around the vehicle. The data in the radio signal includes a request to the mobile unit 2 to respond to the in-vehicle unit 1 and the priority channel information P.

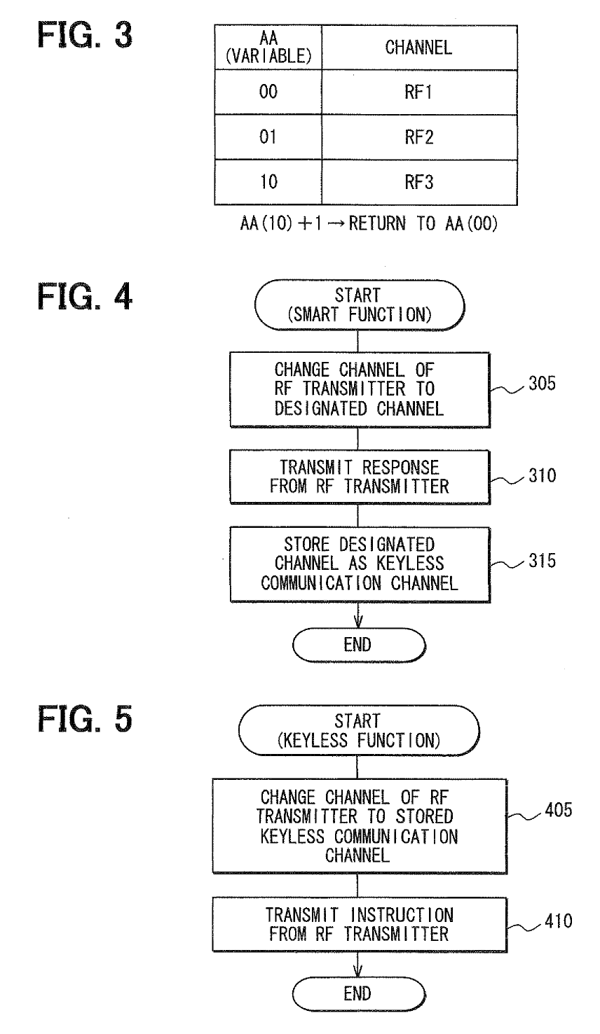

The priority channel memory section 10A stores a plurality of priority channel information P. By registering the priority channel information P in the variables AA, the channel which should be selected to receive the radio signal from the mobile unit 2 first can be determined by referring to a RF channel setting table shown in FIG. 3.

When S115 is executed first time, the registered channel is a channel selected in the latest successful reception of the response from the mobile unit 2 among the channels, which have been tried for receiving the response from the mobile unit 2 in the past.

When the mobile unit 2 receives the radio signal of LF band from the in-vehicle unit 1 at its LF receiver 22, the controller 20 starts the processing shown in FIG. 4. The controller 20 changes or sets at S305 its channel of communication to be used by its RF transmitter 23 in response to the data of the received radio signal. Since the radio signal received from the in-vehicle unit 1 includes the priority channel information P, the controller 20 can readily select the channel or frequency designated by the data received from the in-vehicle unit 1.

The controller 20 then drives the RF transmitter 23 to transmit the radio signal in UHF band including a response to the in-vehicle unit 1 at S310. This response includes an identification code (ID) specifically assigned to the mobile unit 2 The controller 20 stores at S315 the frequency designated by the in-vehicle unit 1 as a keyless entry communication frequency in the keyless entry channel memory section 25, and ends its processing for the smart entry function.

When the radio signal of response is transmitted from the mobile unit 2, the RF receiver 13 in the in-vehicle unit 1 receives it at S120 (FIG. 2) by using the channel selected based on the priority channel information P.

The RF receiver 13 may not be able to properly receive the radio signal of response from the mobile unit 2 in some circumstances. For instance, the radio signal reception will be impossible when the radio signal is jammed with an interfering signal of the same frequency. It is also possible that the RF receiver 13 will receive a radio signal including different data. Therefore, the controller 10 checks at S125 whether the ID included in the response is the same as that stored in the in-vehicle unit 1, thereby checking if the mobile unit 2 is an authorized one. If both codes agree (YES), the controller 10 determines that the response of the mobile unit 2 has been properly received. In this instance, the controller 10 performs a predetermined operation such as unlocking doors and engine starting control at S130.

The controller 10 stores, at S135, the information in the variable M in the priority channel memory section 10A to be used as the priority channel to be selected with the highest priority next time, thus ending the processing of the in-vehicle unit 1 for the smart entry function. Some nonvolatile memories have a limitation in the number of times of updating or rewriting data. If such a memory is used as the priority channel memory unit 10A, the information registered in the variable M may be compared with the priority channel information P already stored in the memory unit 10A, and the priority channel information in the memory section 10A may be updated at S135 only when the information differ from each other.

If both IDs do not agree (NO) at S125, it is likely that the RF receiver 13 could not receive the response from the mobile unit 2 properly because of, for example, jamming by interfering signals of the same or similar frequency. In this case, the in-vehicle unit 1 retries a reception of response by changing the channel or frequency. Specifically, the controller 10 increments the variable AA by one to AA+1 at S140. Thus, the channel to be selected from the channel setting table is changed to the next one.

As shown in FIG. 3, by incrementing the variable in the order of 00, 01 and 10, the channel selected becomes RF1, RF2 and RF3, respectively, If the variable 10 is incremented further, it returns to 00.

The controller 10 checks at S145 whether the channel of the variable AA updated at S140 is the same as the channel of the priority channel information P. If they do not agree (NO), the controller 10 determines that the channel has been changed and returns to S115 to repeat the similar processing from 5115. The processing of sequence of S115, S120, S125, S140 and S145 is repeated, until both IDs agree (YES at S125) or until all the channels are tried without resulting in agreement of IDs (YES at S145).

If both IDs agree (YES at S125) during the above repetition from S115 to S145, the controller 10 determines that the response from the mobile unit 2 has been duly received. The controller 10 then executes S130 to perform the predetermined control as described above.

The in-vehicle unit 1 and the mobile unit 2 also operate as a remote keyless entry system to perform the remote keyless entry function. In this system, the mobile unit 2 executes the processing shown in FIG. 5.

Specifically, at S405, the controller 20 in the mobile unit 2 changes the channel to be used by the RF transmitter 23 to the channel selected from the keyless communication channel memory 25. The channel selected from the channel memory 25 is the channel that was updated and stored at S135 executed last time. This channel was notified from the in-vehicle unit 1 as the priority channel in the latest execution of the smart entry function. The controller 20 then drives the RF transmitter 23 to transmit a radio signal of instruction at S410. The radio signal for performing the remote keyless entry function is transmitted by way of the channel selected and changed at S405. Therefore, it will be received by the RF receiver 13 in the in-vehicle unit 13 S with the highest probability.

According to the above embodiment, the electronic key system can automatically select and set the channel without selecting and setting the channel by manually operating a switch.

Further, when the in-vehicle unit 1 successfully receives the response from the mobile unit 2 by using a different channel as a retry after failing to successfully receive the response from the mobile unit 2 by using one of channels, the in-vehicle unit 1 first selects the last successful channel in transmitting or receiving radio signals to and from the mobile unit 2. As a result, the channel to be used first for each transmission and reception of radio signals will enable communications with high probability of success in comparison to a case, in which channels are selected always in a predetermined order. Thus, the channel selection for the least jamming can be made in a short time, and the authentication of the mobile unit 2 can be finished in the least time.

In addition, when the electronic key system operates as the remote keyless entry system, the instruction signal is transmitted from the mobile unit 2 to the in-vehicle unit 1 by using the same channel, which was successfully used in the latest radio signal communications in the smart entry operation. As a result, the in-vehicle unit 1 can receive the radio signal of remote keyless entry operation instruction from the mobile unit 2 and authenticate the mobile unit 2 in the shortest possible time as in the case of the smart entry operation.

The above embodiment may be modified in many ways.

For example, as long as the channel by which the response has been successfully received is designated as the priority channel and selected automatically first in the next reception operation, the other channels that are selected following the priority channel may be determined in any order of sequence. That is, the order may be at random or predetermined. In any case, since the priority channel is selected first to receive the response, the interval required from the reception of the response to the authentication of the mobile unit can be shortened. Even if it took some time to successfully authenticate the mobile unit first time, the subsequent authentications can be attained in a shorter time after changing the priority channel based on the first reception and authentication.

The above embodiment implemented in a vehicle may be modified to other electronic key systems for other objects such as office buildings or private homes.

What is claimed is:

1. An electronic key system for a control object comprising:
an in-object unit provided in the control object; and
a mobile unit for communicating with the in-object unit by radio signals and causing the in-object unit to perform predetermined control in the control object, wherein the mobile unit transmits a response to the in-object unit when receiving a request of response from the in-vehicle unit, characterized in that
the in-object unit is configured to:
select one channel from a plurality of predetermined channels of communication for receiving the response from the mobile unit, and transmit information of the selected channel when transmitting the request of response to the mobile unit so that the mobile unit transmits the response by way of the selected channel;
select another channel from the plurality of predetermined channels automatically when failing to receive the response transmitted from the mobile unit in response to the request of response, and transmit another request of response and information of the selected another channel so that the mobile unit transmits another response by using the selected another channel; and
select the another channel for next radio communications with the mobile unit automatically after receiving the another response from the mobile unit successfully by using the selected another channel.

2. The electronic key system according to claim 1, wherein:
the mobile unit is configured to transmit an instruction to the in-vehicle unit by using the selected another channel, when operated manually in a predetermined manner by a user; and
the in-object unit is provided in a vehicle to control vehicle doors.

3. The electronic key system according to claim 1, wherein:
the in-object unit transmits the request of response in a radio signal in a frequency band of 100k-200k Hz; and
the mobile unit transmits the response in a radio signal in a frequency band of 300M-400M Hz or 800MHz.

4. An in-object unit for radio communication with a mobile unit in an electronic key system for a control object, the mobile unit comprising:
selection means for selecting a response transmitting channel from a plurality of channels to be used to receive a response from the mobile unit;
transmitter means for transmitting a request of response to the mobile unit together with information about the selected channel to be used in transmitting the response from the mobile unit;
receiver means for receiving the response from the mobile unit by using the selected channel; and
check means for checking whether the response from the mobile unit has been successfully received, characterized in that
the selection means selects another response transmitting channel from the plurality of channels when the check means determines a failure of reception of the response from the mobile unit,
the transmitter means and the receiver means transmits the request of response with the information about the selected another channel and receives the response by using the selected another channel again, and
the selection means automatically selects the another channel first for use with priority over other channels in a next reception of the response from the mobile unit, after the receiver means successfully received the response from the mobile unit by using the selected another channel.

5. The in-object unit according to claim 4, wherein:
the in-object unit is provided in a vehicle to control vehicle doors;
the transmitter means transmits the request of response in a low frequency band; and
the receiver means receives the response in an ultra high frequency band.

6. A mobile unit for radio communication with an in-object unit in an electronic key system for a control object, the mobile unit comprising:
receiver means for receiving a request of response transmitted from the in-object unit, the request accompanying information about a response transmission channel selected from a plurality of channels to be used for transmission of a response to the in-object unit; and
transmitter means for transmitting the response to the in-object unit by using the selected response transmission channel.

7. The mobile unit according to claim 6, further comprising:
memory means for storing the selected response transmission channel received with the request of response;
input means for receiving an input operation by a user; and
controller means for driving the transmitter means to transmit an operation instruction to the in-object unit to the in-object unit by using the stored response transmission channel, the operation instruction being corresponding to the input operation by the user.
